(19) United States
(12) Patent Application Publication
(10) Pub. No.: US 2010/0282623 A1
(43) Pub. Date: Nov. 11, 2010

(54) MEDICAL SHARPS AND WASTE DISPOSAL CONTAINER AND METHOD OF MAKING THE SAME

(75) Inventor: Piyush J. Reshamwala, Crystal Lake, IL (US)

Correspondence Address: ODESTER WHITIKER JR., 4305 ENRIGHT AVE., ST. LOUIS, MO, 63108, US

(73) Assignee: TYCO HEALTHCARE GROUP LP, MANSFIELD, MA (US)

(21) Appl. No.: 12/299,210

(22) PCT Filed: May 2, 2007
(86) PCT No.: PCT/US07/10536

§ 371 Date: Mar. 2, 2009

Related U.S. Application Data
(60) Provisional application No. 60/792,293, filed on Apr. 14, 2006.

(51) Int. Cl. B65D 81/00; B29C 45/00

(52) U.S. Cl. 206/210; 264/328.17

(57) ABSTRACT

A method and apparatus for a medical sharps and waste disposal container made from a composition of polypropylene and an additive is provided. The container has a puncture resistance of at least about 2.8 lbf. The additive is present in an amount sufficient to accelerate degradation of the polypropylene after a predetermined shelf-life.

### FIELD OF THE INVENTION

The present invention is directed to a degradable medical sharps and waste container and a method for forming the degradable medical sharps and waste container.

### BACKGROUND OF THE INVENTION

Plastics have become an important part of modern life and are used in different applications such as packaging, building materials, and consumer products. Plastics are extremely versatile. Some plastics are shrinkable, rigid, flexible, impervious, or selectively permeable. One feature of plastics is that it does not degrade rapidly over time and is relatively inexpensive to manufacture.

One example of a product that is manufactured from plastic is a medical sharps and waste disposal container. Medical sharps and waste disposal containers are a convenient and safe way of disposing contaminated needles, syringes, glass tubes, scalpel blades, and any other sharps and medical waste. Such disposal containers may be used to safely contain, transport, and ultimately destroy potentially infectious sharps. The filled medical sharps and waste disposal containers are considered biomedical/biohazardous waste and are to be disposed of according to strict federal and state guidelines. For example, a medical sharps and waste disposal container may be incinerated on or off site by a facility, or the facility can have the container rendered nonhazardous through various sterilization techniques.

If the medical sharps and waste container is rendered noninfectious by sterilization, most landfills consider the sterilized medical sharps and waste disposal container as municipal solid waste. Therefore, the sterilized medical sharps and waste disposal container is subject only to the same requirements as household garbage and may be disposed of in a permitted, contained landfill. Although plastic medical sharps and waste disposal containers are a safe and efficient way to collect contaminated or spent medical sharps and medical waste, the properties of plastic that make these containers suitable for disposal of medical sharps and medical waste, i.e., impervious to heat and moisture, have a sufficient rigidity and puncture resistance, and the ability to maintain its integrity over time, also present challenges to their disposal. Even though the infectious materials contained within the medical sharps and waste disposal containers have been destroyed (i.e., sterilized), the filled containers still present the problem of occupying a large volume of space in a landfill.

### SUMMARY OF THE INVENTION

According to one exemplary embodiment, a medical sharps and waste disposal container of the present invention is made from a composition of polypropylene and an additive, and has a puncture resistance of at least about 2.8 lbf. The additive is present in an amount sufficient to accelerate degradation of the polypropylene after a predetermined shelf-life.

According to another exemplary embodiment, a medical sharps and waste disposal container of the present invention is made from a composition of polypropylene and an additive, and has impact strength sufficient to prevent the escape of sharps from the container. The additive is present in an amount sufficient to accelerate degradation of the polypropylene after a predetermined shelf-life.

An exemplary method of manufacturing a degradable medical sharps disposal and waste container according to an embodiment of the present invention includes forming a container from a composition of polypropylene and an additive in an amount sufficient to accelerate degradation/biodegradation of the polypropylene in the composition after a predetermined shelf-life. The formed container has a puncture resistance of at least about 2.8 lbf.

Another method of manufacturing a medical sharps and waste disposal container according to an exemplary embodiment of the present invention includes forming pellets containing polypropylene and an additive. The pellets are melted and a medical sharps and waste disposal container is formed by a molding process. The formed container has a puncture resistance of at least about 2.8 lbf. and an impact strength sufficient to prevent the escape of sharps from the container.

A method of disposing of medical sharps and medical waste according to an exemplary embodiment of the invention includes receiving medical sharps in a container made from a composition of polypropylene and an additive in an amount sufficient to accelerate degradation of the polypropylene after a predetermined shelf-life. The container has a minimum puncture resistance of at least about 2.8 lbf. Once the medical sharps and/or waste is received by the disposal container, the container is exposed to a stimulus to initiate degradation/biodegradation of the container.

### BRIEF DESCRIPTION OF THE DRAWINGS

The invention is best understood from the following detailed description when read in connection with the accompanying drawings. It is emphasized that, according to common practice, the various features of the drawing are not to scale. On the contrary, the dimensions of the various features are arbitrarily expanded or reduced for clarity. Included in the drawings are the following figures:

FIG. 1 is an illustration of exemplary medical sharps and medical waste containers that can be rendered degradable according to aspects of the present invention;

FIG. 2 is a flow chart of an exemplary method of manufacturing a medical sharps and waste container according to aspects of the present invention; and

FIG. 3 is a flow chart of an exemplary method of disposing medical sharps and medical waste in an exemplary container according to aspects of the present invention.

### DETAILED DESCRIPTION OF THE INVENTION

Degradation is a process whereby very large molecules are broken into smaller molecules or fragments. Degradation typically occurs when oxygen is incorporated into these molecular fragments. This type of degradation is called is oxidative degradation. Typically, strong plastic films become weak and brittle as a result of oxidative degradation. The plastic “degrades” because the long polymer chains that normally comprise the plastic are broken into shorter, smaller chains. Oxidative degradation may be initiated by mechanical stresses, heat, or exposure to UV light or sunlight. The term “degradable plastic” is defined by the American Society for Testing and Materials (ASTM D883-99) as a plastic designed to undergo a significant change in its chemical structure under specific environmental conditions resulting in a loss of some properties that may vary as measured by standard test methods appropriate to the plastic and the application in a period of time that determines its classification.

According to an exemplary embodiment, the degradation process of the medical sharps and waste disposal container of the present invention is accelerated in such a way as to promote degradation while maintaining an acceptable shelf life for the container. In other words, degradation is accelerated while allowing the container to retain its integrity and performance characteristics for an acceptable period of time. For example, this period of time (or shelf life) can be set at about 30 months. That is, about 30 months after a medical sharps and waste disposal container is produced (during which time it may be in storage, transportation or usage), it still retains its structural integrity yet begins to undergo a significant change in its chemical structure resulting in a loss of some properties that may vary as measured by standard test methods appropriate to the container.

Biodegradation, as distinguished from degradation, is the process by which microorganisms found naturally in the soil (namely, bacteria, fungi or algae) convert a material into a biomass, carbon dioxide, mineral matter, and water. A biomass is understood to include an energy resource derived from organic matter and includes any carbon source on which microorganisms can grow. The term “biodegradable plastic” is defined by the American Society for Testing and Materials (ASTM D883-99) as a degradable plastic in which the biodegradation results from the action of naturally-occurring microorganisms, namely, bacteria, fungi, and algae.

Once accelerated degradation is facilitated (e.g., as a first step), the medical sharps and waste disposal containers of the present invention can be subjected to biodegradation (e.g., as a second step). According to an exemplary embodiment, the medical sharps and waste disposal container is rendered biodegradable upon exposure to microorganisms found naturally in the soil (namely, bacteria, fungi or algae).

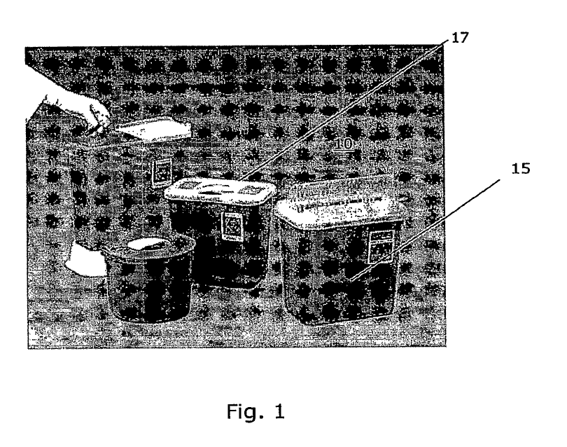

FIG. 1 illustrates exemplary medical sharps and waste containers configured for accelerated degradation and that can be rendered biodegradable according to aspects of the present invention. For example, container 10 has a base and a top and is comprised of a plurality of walls 15. Container 10 may also include a lid 17 which may have various configurations. The walls 15 and lid 17 have a thickness of approximately 0.050 inches to 0.075 inches, and more preferably have a thickness of approximately 0.060 inches to 0.065 inches. Container 10 is adapted to receive medical sharps and medical waste. Walls 15 are made from a composition of polypropylene and an additive that accelerates degradation after the predetermined shelf life. The lid 17 is preferably also made from a composition of polypropylene and an additive that accelerates degradation, but does not have to be made from such a composition. According to an exemplary embodiment, the composition forming walls 15 of container 10, and also possibly lid 17, comprises about 90% to about 100% polypropylene by weight of the container.

An additive is provided in the container, such as container 10, in a sufficient amount to accelerate degradation of the polypropylene in the composition. One exemplary additive is manufactured by EPI Environmental Technologies Inc. of Vancouver, British Columbia, Canada under the trademark TDPA® (Totally Degradable Plastic Additive). Another exemplary additive is manufactured by ECM Biofilms, Inc. of Painesville, Ohio under the tradename ECM Masterbatch Pellets. Yet another exemplary additive is manufactured by Symphony Plastic Technologies of the United Kingdom and distributed by Degradable Plastic Products Inc. of Toronto, Ontario, Canada under the trademark d₂w®. Additives of this nature are described in U.S. Pat. No. 5,854,304; U.S. Patent Application Publication No. 2004/0062884; and PCT International Application Publication No. WO 2005/017015, each of which is incorporated by reference. The additives in these patent documents are generally described for use in thin film structures, for example, plastic bags and the like.

When the additive is added to plastic resins (namely, polypropylene, polyester, or polystyrene) in various concentrations, the manufactured plastic product will have an accelerated rate of degradation and can be ultimately rendered biodegradable. Once degradation and biodegradation are complete, all that remains of the plastic and the additive is carbon dioxide, water, mineral matter and biomass. By varying the concentration and type of additive in the plastic composition, the plastic product formed by the composition will begin its accelerated degradation and be can be rendered biodegradable within a desired timeframe. Exemplary timeframes in which the medical sharps disposal container of the present invention begins its accelerated degradation (so as to lose some of its integrity and performance characteristics) include at least about 20-40 months, preferably at least about 25-35 months, and most preferably at least about 30 months. The additive according to an exemplary embodiment of the present invention is present in an amount of up to about 10%, preferably between about 1-10%, and more preferably between about 3-5% by total weight of the container, as explained in PCT International Application Publication No. WO 2005/017015.

The degradation process is accelerated by the additive and typically begins with the breakdown of a large polymer chain having an average molecular weight of up to 300,000 Daltons into smaller polymer chains by oxidative degradation. Degradation continues by oxygenating the exposed ends of the smaller polymer chains to form aldehydes, ketones, carboxylic acids, and alcohols. The degradation process is initiated upon exposure to heat, UV light (e.g., sunlight), moisture, and mechanical stresses. One or any combination of these stimuli begins the degradation process of a product having the composition of the present invention. Biodegradation begins when microorganisms consume the oxygenated ends resulting from the degradation process to reduce the end of the polymer chains two carbon atoms at a time. When the microorganism consumes the oxygenated ends, the polymer backbone end is again exposed, oxygenated (i.e., degraded), and consumed by the microorganisms (i.e., biodegraded); thus repeating the degradation/biodegradation cycle. Degradation can occur without biodegradation or degradation and biodegradation can proceed simultaneously in concert as described above.

The medical sharps and waste disposal container of the present invention, although having an accelerated degradation process and which can be rendered biodegradable, maintains structural characteristics that makes it suitable as a container for disposal of medical sharps and medical waste. One such structural characteristic is puncture resistance. ASTM-F2132 provides a test procedure and performance requirement for the puncture resistance of materials used in the construction of containers for discarded medical waste, needles and other sharps. This test specification establishes (1) the average puncture force and (2) a minimum value of puncture force that container materials must withstand when following the test procedure. According to one exemplary embodiment, the medical sharps and waste disposal container of the present invention has an average puncture resistance of at least about 3.4 lbf., at least about preferably 5.0 lbf., wherein the minimum requirement for any single measurement is preferably at least about 2.8 lbf.

Another structural characteristic is impact strength. A test procedure that measures impact strength is ASTM-D5628, which determines the relative ranking of materials according to the energy required to crack or break flat, rigid plastic specimens under various specified conditions of impact of a free-falling dart. Another test for impact strength is to drop a filled, medical sharps and waste disposal container from a predetermined height (the height depends on the size and weight of the container) onto a hard surface. The container fails this impact strength test when the impact of the drop causes a medical sharp or other medical waste to escape from the container. For example, a filled, 2 gallon medical sharps disposal container weighing about 1.0 lbs was dropped from a height of 36 inches. If no medical sharps or medical waste escaped from the container, either through a breach in a wall or the lid of the container, after being drop from the predetermined height, the container is determined to have a sufficient impact strength.

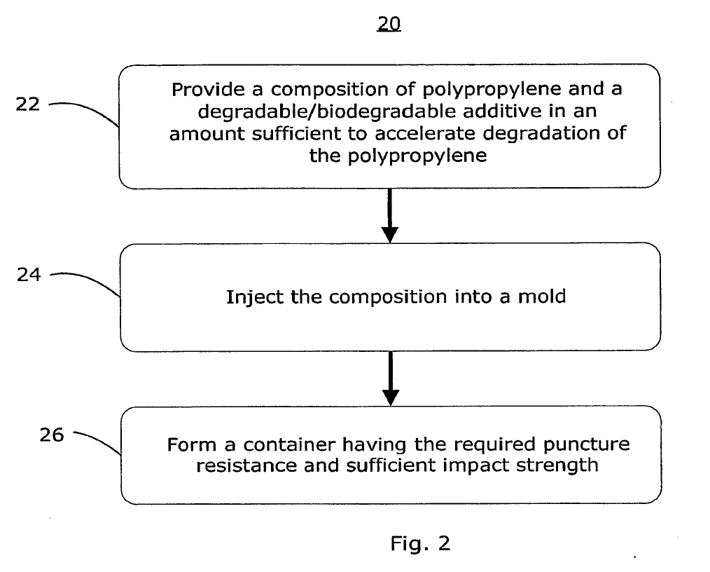

Degradable sharps and medical waste disposal containers, according to exemplary methods of the invention, are manufactured by conventional plastic fabrication processes including, but not limited to, plastic vacuum forming, thermoset injection molding, blow molding, rotational molding, thermoforming, structural foam molding, compression molding, resin transfer molding (RTM), coating, and dipping. For example, FIG. 2 illustrates an exemplary method 20 of forming a medical sharps and waste disposal container of the present invention. According to exemplary method 20, a composition of polypropylene and an additive in an amount sufficient to accelerate degradation of the polypropylene is provided in step 22. According to another exemplary embodiment, a composition of polypropylene and the additive is pelletized and provided in pellet form. The composition is then injected into a mold in step 24. In step 26, a container is formed having a sufficient puncture resistance and impact strength to prevent medical sharps and medical waste from escaping from the container.

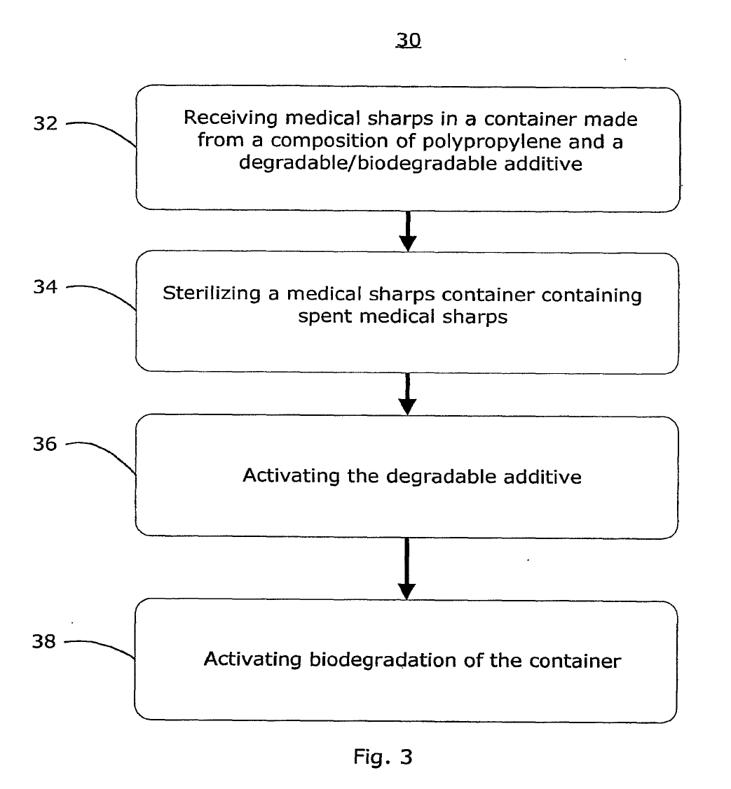

An exemplary method of disposing medical sharps and medical waste according to an embodiment of the present invention is illustrated in the flow chart of FIG. 3. The disposal method 30 includes step 32 of receiving medical sharps and/or medical waste in a container comprising polypropylene and an additive in an amount sufficient to accelerate degradation of the polypropylene after a predetermined shelf-life. To dispose of the medical sharps container, the spent medical sharps and/or medical waste is sterilized as shown in step 34. Appropriate sterilization techniques include those methods that render the potentially infectious medical sharps and waste noninfectious. Exemplary methods include steam (autoclaving), gravity displacement, dynamic air removal (pre-vac), dry heat, convection heat, ethylene oxide, plasma (hydrogen peroxide plasma or gas plasma), and peracetic acid treatment.

As shown in step 36, after sterilization, the accelerated degradation of the medical sharps and waste disposal container is activated. Activation of the accelerated degradation is initiated upon exposure to mechanical and/or chemical stimuli including mechanical shredding, heat, or exposure to UV light (e.g., sunlight) or moisture. As shown in step 38, after accelerated degradation is activated, biodegradation of the medical sharps and waste disposal container is activated. Activation of the biodegradation process is initiated upon exposure to microorganisms found naturally in the soil (namely, bacteria, fungi or algae).

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

What is claimed:

1. A disposal container adapted to receive medical sharps or medical waste, the container comprising polypropylene and an additive in an amount sufficient to accelerate degradation of said polypropylene after a predetermined shelf-life, said container having a puncture resistance of at least about 2.8 lbf.

2. The disposal container of claim 1, wherein the container has an average puncture resistance of at least about 3.4 lbf.

3. The disposal container of claim 1, wherein the container has an average puncture resistance of at least about 5.0 lbf.

4. The disposal container of claim 1, wherein the container includes walls having a thickness of approximately 0.050 inches to 0.075 inches.

5. The disposal container of claim 1, wherein the container includes walls having a thickness of approximately 0.060 inches to 0.065 inches.

6. The disposal container of claim 1, wherein the container has an impact strength sufficient to prevent the medical sharps or medical waste from escaping from the container.

7. The disposal container of claim 1 further comprising a lid comprising polypropylene and an additive in an amount sufficient to accelerate degradation of said polypropylene after a predetermined shelf-life, said lid having a puncture resistance of at least about 2.8 lbf.

8. A disposal container adapted to receive medical sharps or medical waste, the container comprising polypropylene and an additive in an amount sufficient to accelerate degradation of said polypropylene after a predetermined shelf-life, said container having an impact strength sufficient to prevent the medical sharps or medical waste from escaping from the container.

9. The disposal container of claim 8, wherein the container has a puncture resistance of at least about 2.8 lbf.

10. The disposal container of claim 8, wherein the container has an average puncture resistance of at least about 3.4 lbf.

11. The disposal container of claim 8, wherein the container has an average puncture resistance of at least about 5.0 lbf.

12. The disposal container of claim 8, wherein the container includes walls having a thickness of approximately 0.050 inches to 0.075 inches.

13. The disposal container of claim 8, wherein the container includes walls having a thickness of approximately 0.060 inches to 0.065 inches.

14. The disposal container of claim 8 further comprising a lid comprising polypropylene and an additive in an amount sufficient to accelerate degradation of said polypropylene after a predetermined shelf-life, said lid having an impact strength sufficient to prevent the medical sharps or medical waste from escaping from the container or lid.

15. A method of manufacturing a medical sharps or waste disposal container comprising the steps of:
injecting a composition comprising polypropylene and an additive in an amount sufficient to accelerate degradation of the polypropylene after a predetermined shelf-life; and
forming a container having a puncture resistance of at least about 2.8 lbf.

16. The method of claim 15, wherein the forming step comprises forming a container having an average puncture resistance of at least about 3.4 lbf.

17. The method of claim 15, wherein the forming step comprises forming a container having an average puncture resistance of at least about 5.0 lbf.

18. The method of claim 15, wherein the injecting step comprises injecting a composition having polypropylene and an additive to define walls having a thickness of approximately 0.050 inches to 0.075 inches.

19. The method of claim 15, wherein the injecting step comprises injecting a composition having polypropylene and an additive to define walls having a thickness of approximately 0.060 inches to 0.065 inches.

20. The method of claim 15, wherein the forming step comprises forming a container having an impact strength sufficient to prevent the medical sharps or medical waste from escaping from the container.

21. The method of claim 15 further comprising the step of forming a lid from a composition comprising polypropylene and an additive in an amount sufficient to accelerate degradation of the polypropylene after a predetermined shelf-life.

22. A method of disposing medical sharps or medical waste comprising the steps of:
receiving medical sharps and/or medical waste in a container comprising polypropylene and an additive in an amount sufficient to accelerate degradation of the polypropylene after a predetermined shelf-life and having a minimum puncture resistance of at least about 2.8 lbf.;
initiating degradation of the container; and
initiating biodegradation of the container.

23. The method of claim 22, further comprising the step of sterilizing the container and the medical sharps and/or the medical waste.

24. The method of claim 22, wherein the initiating degradation step comprises mechanically shredding the container and the medical sharps and/or waste.

25. The method of claim 22, wherein the initiating degradation step comprises exposing the container to moisture.

26. The method of claim 22, wherein the initiating degradation step comprises exposing the container to UV light or sunlight.

27. The method of claim 22, wherein the initiating biodegradation step comprises exposing the container to soil.

28. The method of claim 22, wherein the initiating biodegradation step comprises exposing the container to a stimulus selected from the group consisting of microorganisms, bacteria, fungi and algae or combinations thereof.

29. A method of manufacturing a medical sharps or waste disposal container comprising:
forming pellets containing polypropylene and an additive; and
molding the pellets into a medical sharps or waste disposal container having a puncture resistance of at least about 2.8 lbf. and an impact strength sufficient to prevent the sharps or medical waste from escaping from the container.
